(19) United States
(12) Patent Application Publication
(10) Pub. No.: US 2010/0253485 A1
(43) Pub. Date: Oct. 7, 2010

(54) TOUCH SCREEN DEVICE

(76) Inventors: Dong Sun Park, Seoul (KR); Yeon Ho Son, Gyunggi-do (KR); Jae Kyung Kim, Gyunggi-do (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/465,513

(22) Filed: May 13, 2009

(30) Foreign Application Priority Data
Apr. 3, 2009 (KR) 10-2009-0028969

(51) Int. Cl. G06F 3/041; G08B 6/00

(52) U.S. Cl. 340/407.2; 345/173

(57) ABSTRACT

Disclosed herein is a touch screen device. The touch screen device includes a flexible rectangular touch screen panel, an actuator, and a rectangular bezel. The touch screen panel bends when subject to a user's touch. The actuator is mounted to the touch screen panel, thus applying vibration to the touch screen panel. The bezel includes a widthwise mounting part to which part of the touch screen panel is mounted, a lengthwise edge facing the actuator, and a groove having a shape corresponding to that of the actuator so that the actuator does not make contact with the bezel.

### CROSS REFERENCE TO RELATED APPLICATION(S)

This application claims the benefit of Korean Patent Application No. 10-2009-0028969, filed on Apr. 3, 2009, entitled “Touch Screen Device”, which is hereby incorporated by reference in its entirety into this application.

### BACKGROUND OF THE INVENTION

1. Field of the Invention

The present invention relates generally to touch screen devices and, more particularly, to a touch screen device, in which a groove is formed in the bezel of the touch screen device, so that an actuator vibrates while continuously maintaining a non-contact state with the bezel, thus allowing the sensation of touching to be more easily sensed when a user touches a touch screen panel.

2. Description of the Related Art

Recently, as a user's demand for the convenient use of electronic products increases, a touch screen which performs input by touching the screen has been universalized. A touch screen device includes a concept which reflects a user's intuitive experience in an interface and diversifies feedback, in addition to the concept of inputting by touching the device.

The touch screen device is advantageous in that saving on space and convenience are achieved, manipulability is improved, it is easy to change a specification, the valuation by consumers is high, and it is easy to be operated in conjunction with IT equipment. Owing to these advantages, everyone regardless of age or sex can easily and rapidly use an electronic device using the touch screen, so that the touch screen has been widely used in a variety of fields including the fields of industry, traffic, service, medical service and mobile-equipment.

Among the touch screen device, the popularity of touch screen mobile phones has gradually increased. As such, the reason why the popularity of the touch screen mobile phones has increased recently is because the development of the hardware of mobile phones has reached a limit, and the appearance of devices such as a camera phone, a slim phone, and a slide-up phone is not important to a consumer when selecting a product. Currently, a user has further become sensitive to a vibrating sensation which is felt when he or she touches the mobile phone, rather than the appearance.

Therefore, when selecting a mobile phone, one thing important for a user who has a sensitive sense of touch is the vibrating sensation felt when the mobile phone is touched, in addition to the appearance of the mobile phone.

FIG. 5 illustrates a conventional touch screen mobile phone. The touch screen mobile phone includes a touch screen cover 11, a touch screen panel 12, an acrylic plate 13 and a bezel 14.

The touch screen cover 11 is perfectly secured to the touch screen panel 12, and the acrylic plate 13 or a tempered glass adheres integrally to the bottom of the touch screen panel 12. An LCD and the bezel 14 are assembled with the integrated touch screen panel 12.

The conventional touch screen mobile phone is operated such that its entire portion is vibrated by an actuator such as a vibration motor or a linear motor, thus giving feedback to a user. However, this is problematic in that feedback is transmitted from the entire portion of the mobile phone when a user touches the touch screen panel, so that he or she feels reduced vibration.

Therefore, research on the construction of an actuator and a bezel which are capable of increasing the vibration sensation when a user touches the touch screen panel 12 is required.

### SUMMARY OF THE INVENTION

The present invention has been made in an effort to provide a touch screen device, in which a groove is formed in the bezel of the touch screen device, so that an actuator vibrates while continuously maintaining a non-contact state with the bezel, thus allowing the sensation of touching to be more easily sensed when a user touches a touch screen panel.

A touch screen device according to an embodiment of the present invention includes a touch screen device including a flexible rectangular touch screen panel, an actuator, and a rectangular bezel. The touch screen panel bends when subject to a user's touch. The actuator is mounted to the touch screen panel, thus applying vibration to the touch screen panel. The bezel includes a widthwise mounting part to which part of the touch screen panel is mounted, a lengthwise edge facing the actuator, and a groove having a shape corresponding to that of the actuator so that the actuator does not make contact with the bezel.

The actuator may comprise a pair of actuators which are provided on lengthwise edges of the touch screen panel in such a way as to face each other.

A pair of grooves having the shape corresponding to that of the pair of actuators may be formed along lengthwise edges of the bezel so that the actuators do not make contact with the bezel when the actuators vibrate.

The actuator may comprise a pair of actuators which are provided on widthwise edges of the touch screen panel in such a way as to face each other.

A pair of grooves having the shape corresponding to that of the pair of actuators may be formed along widthwise edges of the bezel so that the actuators do not make contact with the bezel when the actuators vibrate.

The actuator may be contracted or expanded in a longitudinal direction by external power, so that the touch screen panel is vibrated up and down.

A mounting part of the bezel may protrude from an edge of the bezel so that the touch screen panel bends easily.

The groove may be longer in length than the actuator.

The actuator may be a piezoelectric actuator, a linear actuator, or a polymer actuator.

### BRIEF DESCRIPTION OF THE DRAWINGS

FIG. 1 is an exploded perspective view illustrating a touch screen device according to the first embodiment of the present invention;

FIG. 2 is a sectional view illustrating the touch screen device according to the first embodiment of the present invention;

FIG. 3 is an exploded perspective view illustrating a touch screen device according to the second embodiment of the present invention;

FIG. 4 is a perspective view illustrating the assembled touch screen device according to the present invention; and

FIG. 5 is an exploded perspective view illustrating a conventional touch screen device.

### DESCRIPTION OF THE PREFERRED EMBODIMENTS

Hereinafter, touch screen devices according to the preferred embodiments of the present invention will be described in detail with reference to the accompanying drawings.

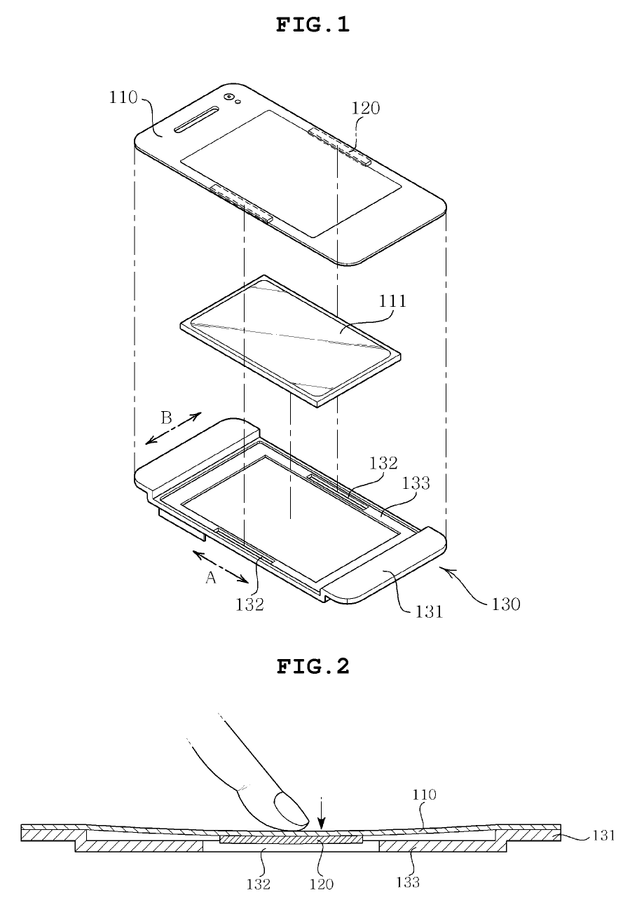

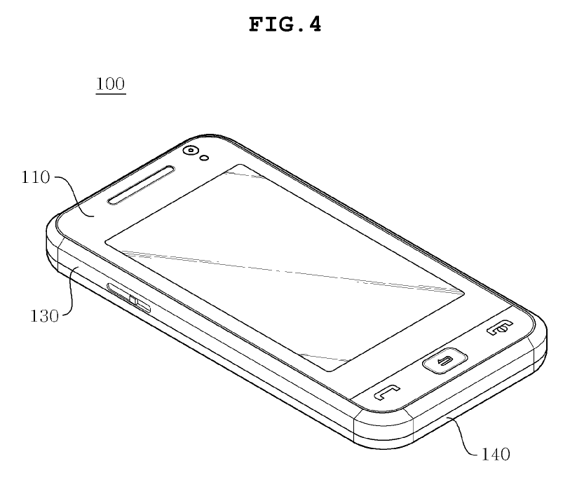

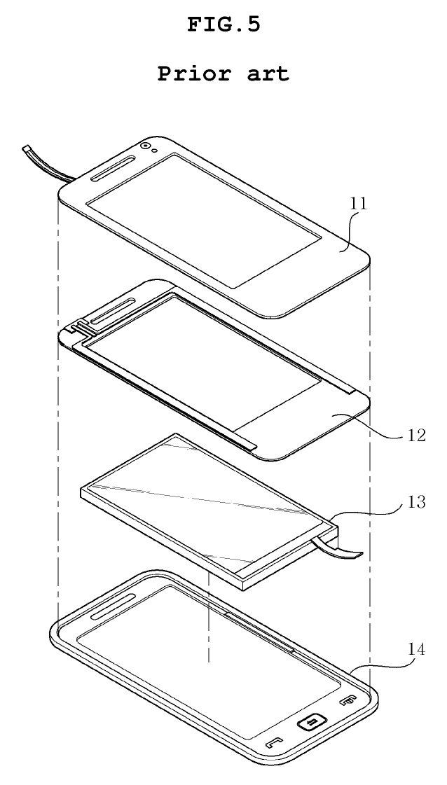

FIGS. 1 through 4 illustrate touch screen devices 100 according to the preferred embodiments of the present invention. Each touch screen device 100 includes a touch screen panel 110, actuators 120, and a bezel 130.

The touch screen panel 110 is subjected to the pressure of an electronic device. Generally, the touch screen panel 110 is the outer surface which receives an external signal input by a user's finger or a stick. Further, the touch screen panel 110 is a flexible rectangular panel which is bendable by a user's touch.

The actuators 120 are mounted to the touch screen panel 110 and apply vibration to the touch screen panel 110. Each actuator 120 is the device which is subjected to a user's pressure transmitted through the touch screen panel 110 provided on the upper surface of a body of the electronic device and controls a rated voltage, thus maintaining vibration so that the user can feel a predetermined magnitude of vibration.

The bezel 130 is the part to which the touch screen panel 110 is attached. The bezel 130 is provided with widthwise mounting parts 131, lengthwise edges 133, and grooves 132. Part of the touch screen panel 110 is secured to the widthwise mounting parts 131. The lengthwise edges 133 face the actuators 120. Each groove 132 is formed to correspond to the shape of each actuator 120, so that the actuator 120 is not in contact with the bezel 130.

As shown in FIG. 1, according to the first embodiment of the present invention, a pair of actuators 120 is mounted to the lengthwise edges of the touch screen panel 110 in such a way as to face each other. Further, a pair of first grooves 132 corresponding to the shape of the pair of actuators 120 is formed in first edges 133 extending in the longitudinal direction A of a first bezel 130, so that the actuators 120 mounted to the lengthwise edges of the touch screen panel 110 are not in contact with the first bezel 130 during the vibration of the actuators 120.

A display unit 111 is mounted between the touch screen panel 110 and the bezel 130 to form a screen.

Further, as shown in FIG. 2, when a user touches the touch screen panel 110, the touch screen panel 110 is bent downwards due to the expansion of the length of each actuator 120 to which the sensation of touching is applied. However, since the first grooves 132 are formed to correspond to the actuators 120, the actuators 120 are not in contact with the first bezel 130 during the vibration, thus allowing a user to more easily feel the vibrating sensation.

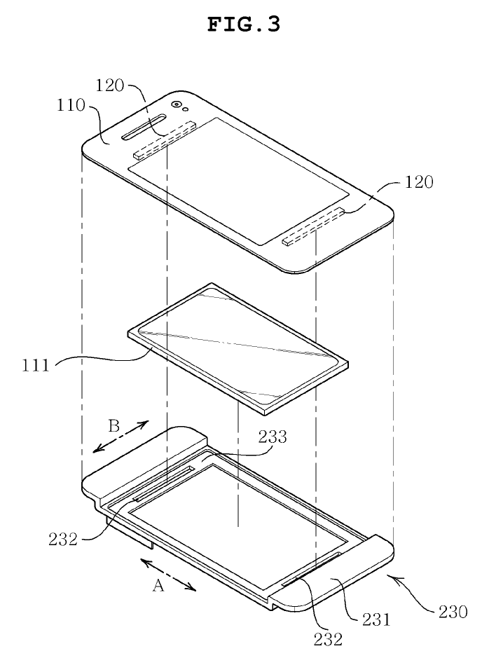

Meanwhile, as shown in FIG. 3, according to the second embodiment of the present invention, a pair of actuators 120 is mounted to the widthwise edges of the touch screen panel 110 in such a way as to face each other. Further, a pair of second grooves 232 corresponding to the shape of the pair of actuators 120 is formed in second edges 233 extending in the widthwise direction B of a second bezel 230, so that the actuators 120 mounted to the widthwise edges of the touch screen panel 110 are not in contact with the second bezel 230 during the vibration of the actuators 120.

A casing 140 surrounds the touch screen panel 110, the actuators 120 and the bezel 130 such that they are secured to each other, and protects them from an exterior.

In the touch screen device 100 according to the present invention, when the touch screen panel 110 is pressed by a user's touch, the actuators 120 do not contact the bezel 130 or 230 because of the grooves 132 or 232 formed in the bezel 130 or 230.

When the actuators 120 of the present invention are contracted or expanded in a longitudinal direction by external power, the touch screen panel 110 is vibrated up and down. Each actuator 120 may comprise a piezoelectric actuator, a linear actuator, or a polymer actuator which may generate vibration.

Further, the mounting parts 131 or 231 of the bezel 130 or 230 protrude from the edges 133 or 233 so that the touch screen panel 110 is easily bent. Since each groove 132 or 232 is longer than the actuator 120, the actuator 120 does not always contact the groove 132 or 232 during the vibration of the actuator 120.

Thus, the grooves 132 or 232 are formed in the bezel 130 or 230, so that the actuators 120 vibrate while continuously maintaining a non-contact state with the bezel 130 or 230. Thereby, a user can more easily feel the sensation of touching when the touch screen panel 110 is touched.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

As described above, the present invention provides a touch screen device, in which a groove is formed in the bezel of the touch screen device, so that an actuator vibrates while not continuously coming into contact with the bezel, thus allowing a user to more easily feel the sensation of touching when the touch screen panel is touched.

What is claimed is:

1. A touch screen device, comprising:
a flexible rectangular touch screen panel which bends when subject to a user's touch;
an actuator mounted to the touch screen panel, thus applying vibration to the touch screen panel; and
a rectangular bezel, including:
a widthwise mounting part to which part of the touch screen panel is mounted;
a lengthwise edge facing the actuator; and
a groove having a shape corresponding to that of the actuator so that the actuator does not make contact with the bezel.

2. The touch screen device as set forth in claim 1, wherein the actuator comprises a pair of actuators which are provided on lengthwise edges of the touch screen panel in such a way as to face each other.

3. The touch screen device as set forth in claim 2, wherein a pair of grooves having the shape corresponding to that of the pair of actuators is formed along lengthwise edges of the bezel so that the actuators do not make contact with the bezel when the actuators vibrate.

4. The touch screen device as set forth in claim 1, wherein the actuator comprises a pair of actuators which are provided on widthwise edges of the touch screen panel in such a way as to face each other.

5. The touch screen device as set forth in claim 4, wherein a pair of grooves having the shape corresponding to that of the pair of actuators is formed along widthwise edges of the bezel so that the actuators do not make contact with the bezel when the actuators vibrate.

6. The touch screen device as set forth in claim 1, wherein the actuator is contracted or expanded in a longitudinal direction by external power, so that the touch screen panel is vibrated up and down.

7. The touch screen device as set forth in claim 1, wherein a mounting part of the bezel protrudes from an edge of the bezel so that the touch screen panel bends easily.

8. The touch screen device as set forth in claim 1, wherein the groove is longer in length than the actuator.

9. The touch screen device as set forth in claim 1, wherein the actuator is a piezoelectric actuator, a linear actuator, or a polymer actuator.
